(19) United States
(12) Patent Application Publication
(10) Pub. No.: US 2019/0066167 A1
(43) Pub. Date: Feb. 28, 2019

(54) SYSTEM TO DYNAMICALLY MANAGE AND OPTIMIZE THE UTILIZATION OF OUTDOOR ADVERTISING UNITS

(71) Applicant: ADSTRUC, INC., NEW YORK, NY (US)

(72) Inventors: JOSHUA PATRICK WARRUM, NEW YORK, NY (US); SAMUEL JAMES HERBERT, NEW YORK, NY (US); JOHN FRANCIS LARAMIE, NEW YORK, NY (US); ELIANE KABKAB, NEW YORK, NY (US); ANDREW JOSEPH SHULTS, NEW YORK, NY (US); ERIC ISAIAH JUSTUSSON, BROOKLYN, NY (US); NEAL RANJAN SHYAM, BROOKLYN, NY (US)

(21) Appl. No.: 16/174,134

(22) Filed: Oct. 29, 2018

Related U.S. Application Data
(63) Continuation-in-part of application No. 14/500,188, filed on Sep. 29, 2014, now abandoned.
Application No. 14/500,188 is a continuation-in-part of application No. 13/367,007, filed on Feb. 6, 2012, now abandoned.
(60) Provisional application No. 61/590,723, filed on Jan. 25, 2012.
(60) Provisional application No. 61/439,620, filed on Feb. 4, 2011.

(51) Int. Cl. G06Q 30/02

(52) U.S. Cl. CPC G06Q 30/0276; G06Q 30/0205; G06Q 30/0249; G06Q 30/0244

(57) ABSTRACT

A system to dynamically generate, monitor and optimize an advertising campaign includes a processor-based server to process requests received from the client devices. The processor-based server includes a server processor to generate the advertising campaign comprising one or more outdoor advertising units selected based on a campaign budget of the advertiser, target rating point goal, a geolocation, a price, a media format, average audited impressions and an inventory quality coefficient of each outdoor advertising unit in the inventory of available outdoor advertising units for purchase. The server processor monitor availability of previously unavailable outdoor advertising units and track real-time changes to the inventory quality coefficients for each outdoor advertising unit in the updated inventory. The server processor dynamically updates and optimizes the advertising campaign based on the updated inventory quality coefficients for the updated inventory of available outdoor advertising units for purchase.

### RELATED APPLICATIONS

This application is a continuation-in-part application of U.S. application Ser. No. 14/500,188, filed Sep. 29, 2014, which is a continuation-in-part application of U.S. application Ser. No. 13/367,007, filed Feb. 6, 2012, which claims the benefit of U.S. Provisional Application No. 61/439,620, filed Feb. 4, 2011, and U.S. Provisional Application No. 61/590,723, filed Jan. 25, 2012, each of which is incorporated herein by reference in its entirety.

### FIELD OF THE INVENTION

The present invention relates to outdoor advertising, and more specifically, to systems and methods of requesting one or more automatically generated proposals offering outdoor advertising units suitable for supporting an advertising campaign of a buyer.

### BACKGROUND OF THE INVENTION

Outdoor advertising is used effectively in advertising campaigns to reach a target audience and may include any form of advertising found outside of the home. An advertising campaign brings together one or more forms of outdoor advertising throughout a geographic region to reach out to a target audience. However, deciding which of the outdoor advertising systems to include in a campaign or a proposal supporting a campaign is difficult, especially as the number of selectable systems is high. As the difficulty increases, suitable forms of outdoor advertising systems may be easily missed, thereby resulting in a poorly executed pitch for supporting an advertising campaign.

### OBJECT AND SUMMARY OF THE INVENTION

In accordance with an exemplary embodiment of the claimed invention, a system is provided to dynamically generate, monitor and optimize an advertising campaign. The system comprises a database aggregating an inventory of available outdoor advertising units for purchase from a plurality of multimedia owners, a plurality of processor-based client devices, a communications network, and a processor-based server processes requests received from the client devices over said communications network. Each client device is associated with an advertiser or a multimedia owner. The processor-based server comprises a load balancer to decode the requests from said plurality of client devices, and transports responses to said plurality of client devices, and a server processor. The server processor is configured to generate the advertising campaign comprising one or more outdoor advertising units selected based on a campaign budget of the advertiser, target rating point goal, a geolocation, a price, a media format, average audited impressions and an inventory quality coefficient of each outdoor advertising unit in the inventory of available outdoor advertising units for purchase. The server processor is configured to monitor availability of previously unavailable outdoor advertising units and update the inventory of available outdoor advertising units for purchase. The server processor is configured to track real-time changes to the inventory quality coefficient for each outdoor advertising unit in the updated inventory of available outdoor advertising units for purchase to provide an updated inventory quality coefficient for each outdoor advertising unit in the updated inventory of available outdoor advertising units for purchase. The server processor is configured to dynamically update and optimize the advertising campaign based on the updated inventory quality coefficient of said each outdoor advertising unit in the updated inventory of available outdoor advertising units for purchase.

In accordance with an exemplary embodiment of the claimed invention, the aforesaid server processor determines the inventory quality coefficient of each outdoor advertising unit from a weighted arithmetic mean of a set of quality coefficient derived from metadata or metrics of each outdoor advertising unit.

In accordance with an exemplary embodiment of the claimed invention, the media format of each outdoor advertising unit is a digital or non-digital outdoor advertising unit, and the aforesaid server processor is configured to dynamically update and optimize an active advertising campaign for an inventory of digital outdoor advertising units.

In accordance with an exemplary embodiment of the claimed invention, the media format of each outdoor advertising unit is a digital or non-digital outdoor advertising unit, and the aforesaid server processor is configured to dynamically update and optimize prior to an activation of the advertising campaign for an inventory of non-digital outdoor advertising units.

In accordance with an exemplary embodiment of the claimed invention, a system is provided for generating proposals for outdoor advertising units. The system comprises a database aggregating multiple available outdoor advertising units from a plurality of multimedia owners, a plurality of processor-based client devices, each associated with an advertiser or a multimedia owner, a communications network, and a processor-based server. The processor-based server processes HTTP requests received from the client devices over the communications network, and comprises a server processor, a plurality of web servers, at least one postgres server, and a plurality of Resque workers. Each web server processes the HTTP requests, extracts data from the HTTP requests and generates an HTTP response to each HTTP request. The postgres server stores extracted data received from the web servers and provides stored data to the web servers. The server processor decodes and routes the HTTP requests from the client devices to one of the web servers, and transports the HTTP responses to the client devices. The Resque worker performs predefined jobs associated with each HTTP request. The Resque worker transmits emails to client devices associated with multimedia owners in response to an HTTP request comprising requirements for an advertising campaign from a client device associated with an advertiser. The Resque worker transmits emails to the client device associated with the advertiser in response to HTTP requests comprising proposals for said advertising campaign from the client devices associated with the multimedia owners.

In accordance with an exemplary embodiment of the claimed invention, a system is provided for generating proposals for outdoor advertising units. The system comprises a database aggregating multiple available outdoor advertising units from a plurality of multimedia owners, a plurality of processor-based client devices, each associated with an advertiser or a multimedia owner, a communications network, and a processor-based server. The processor-based server processes HTTP requests received from the client devices over the communications network, and comprises a server processor, a plurality of web servers, at least one postgres server, and a plurality of Resque workers. Each web server processes the HTTP requests, extracts data from the HTTP requests and generates an HTTP response to each HTTP request. The postgres server stores extracted data received from the web servers and provides stored data to the web servers. The server processor decodes and routes the HTTP requests from the client devices to one of the web servers, and transports the HTTP responses to the client devices. The Resque worker performs predefined jobs associated with each HTTP request. The Resque worker transmits emails to client devices associated with multimedia owners in response to an HTTP request comprising purchasing information for one or more outdoor advertising units from a client device associated with an advertiser. The Resque worker transmits emails to the client device associated with the advertiser in response to HTTP requests comprising data relating to outdoor advertising units availability from the client devices associated with the multimedia owners.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings in which:

FIG. 1 is a block diagram of a client-server system in accordance with an exemplary embodiment of the claimed invention;

FIG. 2A is a block diagram of a client device in accordance with an exemplary embodiment of the claimed invention;

FIG. 2B is a block diagram of a processor-based server in accordance with an exemplary embodiment of the claimed invention;

FIG. 3 is a block diagram of exemplary proposal engines in accordance with an exemplary embodiment of the claimed invention;

FIG. 4 is a block diagram of the system for generating a proposal in accordance with an exemplary embodiment of the claimed invention;

FIG. 5 a block diagram of the system for generating a purchase order in accordance with an exemplary embodiment of the claimed invention;

FIG. 6 is a block diagram of the radar feature of the system for tracking changes in inventory quality coefficient in a campaign in accordance with an exemplary embodiment of the claimed invention; and

FIG. 7 is a block diagram of the radar feature of the system for adding multiple campaigns to an optimization pool in accordance with an exemplary embodiment of the claimed invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

### DETAILED DESCRIPTION OF THE EMBODIMENTS

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The term “outdoor advertising unit” can refer to data representative of a corresponding physical embodiment of an outdoor advertising system, the outdoor advertising units can be digital or non-digital outdoor advertising systems.

The term “client device” or “user device” represents an information processor or device, such as personal digital assistant, tablet, laptop, PC, terminal, work station, net book, mobile or smart phone, wireless device and other comparable web-enabled or communications-enabled device. The claimed invention is readily implemented by presently available communications apparatus and electronic components. The invention find ready application in virtually all commercial communications networks, including, but not limited to an intranet, a local area network (LAN), a wide area network (WAN), world wide web, a telephone network, a wireless network, and a wired cable transmission system. The client device can access these communications network using BLUETOOTH®, WI-FI® and any other comparable means. BLUETOOTH is a registered trademark of Bluetooth SIG, Inc. and WI-FI is a registered trademark of Wi-Fi Alliance Corporation.

The term “inventory” as used herein refers to out of home (OOH) Media, e.g., billboards. Inventory in the context of the proposal in the claimed invention includes metadata relates specifically to that proposal, e.g., price, dates available, etc. The term OOH as used herein refers to all media formal specifically intended to reach consumers outside their home.

The term “impressions” as used herein are the total number of times people are likely to notice an ad on an OOH display. Gross impressions are those delivered against a demographic audience for an advertising schedule. In-market impressions are the average number of times people that live in a defined market (e.g. a DMA (designated market area) or CBSA (core based statistical area)) are likely to notice an ad on an OOH display. In-market impressions exclude impressions derived from people who travel into or through the market, but live outside of it. In-market Impressions are the audience from which GRPs are calculated. The term “market” as used herein refers to geographically defined areas used to buy and sell media. The standard market definitions are DMAs and CBSAs.

The term “target audience” as used herein refers to any audience reflecting the most desired consumer prospects for a product or service, defined by age, sex, race, ethnicity or income; or their combinations for any geographic definition.

The term “target rating points” or “TRPs” as used herein refer to a total number of in-market impressions from a target audience delivered by an OOH campaign expressed as a percentage of a market population.

The term “inventory quality coefficient” or “IQC” as used herein refers to a quality coefficient applied to Inventory. Preferably, calculated from the weighted arithmetic mean of a set of quality coefficients derived from Inventory metadata or metrics and Advertiser-set importance scores (weights). The term “quality coefficient (QC)” as used herein refers to a non-negative number which is used as a coefficient when weighting values for purposes of optimization. For example, a QC of 1 gives no special weight to the value, while a QC of 2 doubles the value and a QC of 0.5 halves the value.

The term “proposal” as used herein belongs to a specific campaign and contains the inventory available for purchase by an advertiser or buyer. An advertiser is a company buying the OOH inventory for itself or on behalf of another company, and the client or buyer is a company who will purchase the OOH inventory a campaign. The term “campaign” as used herein refers to the interval of time when an advertising campaign is run.

The term “fighting” or “flight dates” as used herein refers to the length of an advertising campaign, sometimes divided into distinct segments over the course of weeks. Flight Dates refers to the start and end date that OOH media will display an ad during the campaign.

The term “scenario” as used herein represents a collection of the inventory that can be purchased for a campaign by the client.

The term “vendor” or “seller” is a company who owns or represents the OOH media or inventory.

As used herein, “processor” and/or “engine” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

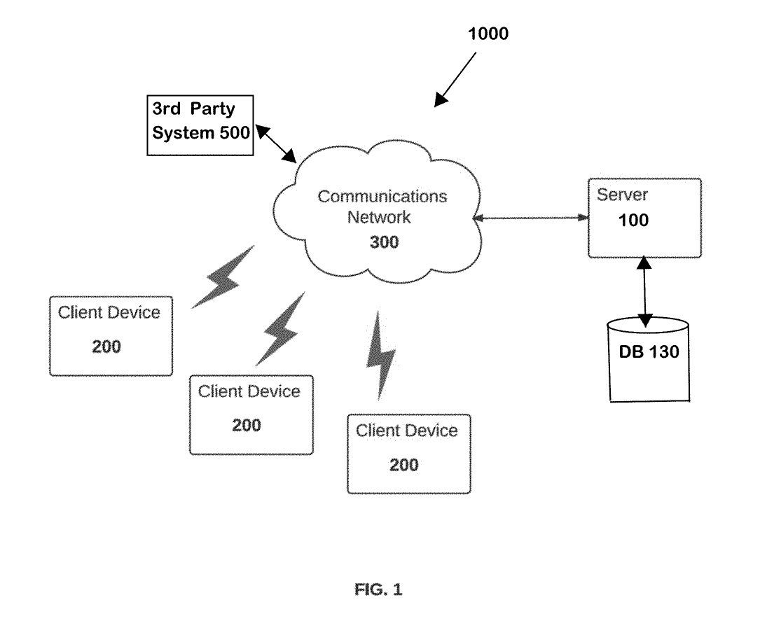

FIG. 1 shows a client-server system architecture in accordance with an exemplary embodiment of the claimed invention. As exemplary shown in FIG. 1, at the system level, the claimed invention comprises one or more web-enabled processor-based client devices 200, one or more processor-based servers 100, one or more databases 130, and a communications network 300. Each client device 200 is associated with a user, such as a multimedia owner or advertiser. Also, one or more third party systems 500 are connected to the server over the communications network 300, e.g., Internet.

In accordance with an exemplary embodiment of the claimed invention, a user is an advertiser or media owner who engages in selling and buying multimedia space. The user accesses the service provider's server 100 via the communications network 300 using a client device 200 by the user. The network 300 is a collection of computers, terminals and other hardware connected by communication channels allowing for the sharing of information. A server 100 executes or runs one or more active processes that respond and reply to client side requests from the client device 200. A database 130 stores a large amount of organized data that is used for search and retrieval.

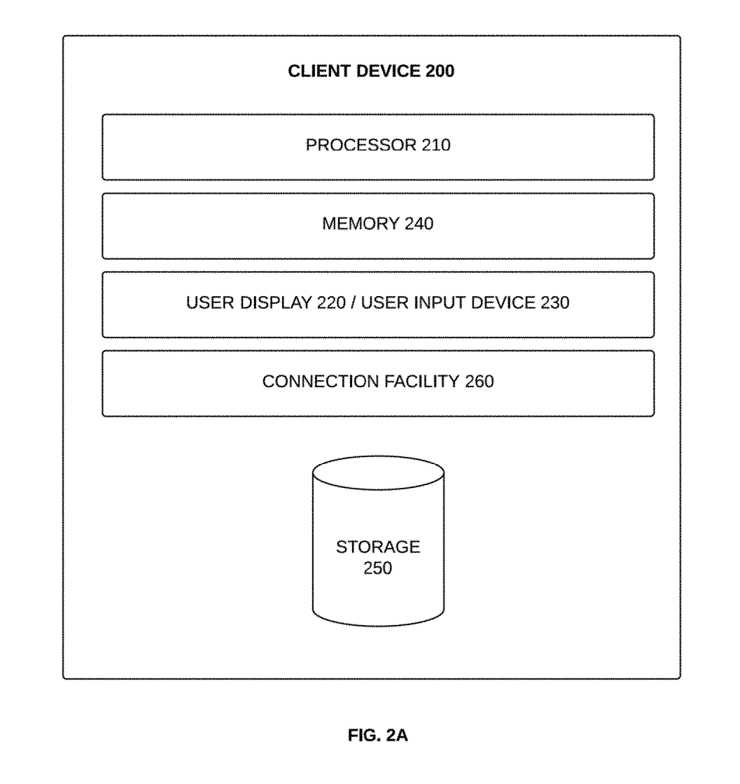

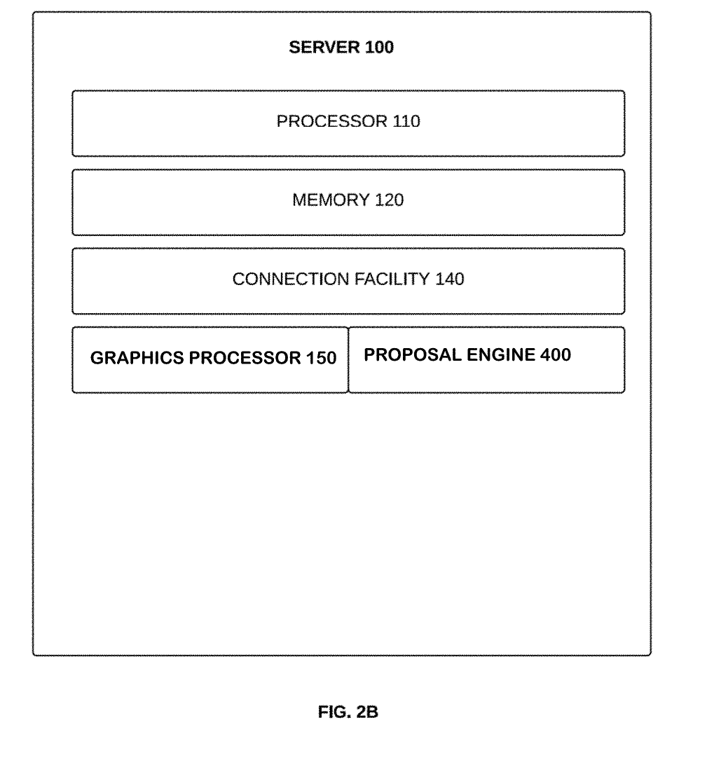

In accordance with an exemplary embodiment of the claimed invention, as shown in FIG. 2A, each client or client device 200 comprises a processor or client processor 210, a display or screen 220, an input device 230 (which can be the same as the display 220 in the case of touch screens), a memory 240, a storage device 250 (preferably, a persistent storage, e.g., hard drive), and a connection facility 260 to connect to the communications network 300.

In accordance with an exemplary embodiment of the claimed invention, as shown in FIG. 2B, the server 100 comprises a processor or server processor 110, a memory 120, a connection facility 140 to connect to the communications network 300, and a graphics processor 150. A server 100 includes but is not limited to a computer system, a single server, or a cluster or collection of computers or servers, or a cloud of computers or servers. Typically, a cluster or collection of servers can be used when the demand on the system 1000 exceeds the reasonable capability of a single server 100.

The user uses a processor-based client device 200 to access the application/program running on the processor-based server 100 over a communications network 300. The network enabled client device 200 includes but is not limited to a computer system, a personal computer, a laptop, a workstation, a terminal, a notebook, a netbook, a tablet or tablet like device, an iPad® (IPAD is a registered trademark of Apple Inc.) or iPad like device, a cell phone, a smart phone, a personal digital assistant (PDA), a mobile device, or a television, or any such device having a screen connected to the communications network 300 and the like. It is appreciated that the communications network 300 can be public or private network.

The communications network 300 can be any type of electronic transmission medium, for example, including but not limited to the following networks: a telecommunications network, a wireless network, a virtual private network, a public internet, a private internet, a secure internet, a private network, a public network, a value-added network, an intranet, a wireless gateway, or the like. In addition, the connectivity to the communications network 300 may be via, for example, by cellular transmission, Ethernet, Token Ring, Fiber Distributed Datalink Interface, Asynchronous Transfer Mode, Wireless Application Protocol, or any other form of network connectivity.

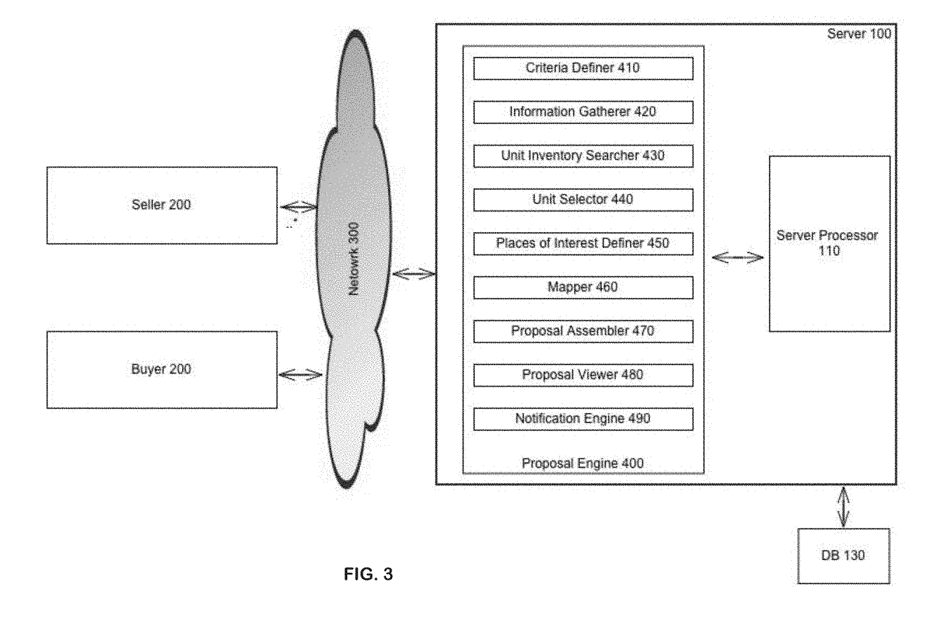

The system 1000 comprises one or more databases 130 aggregating multiple available outdoor advertising units and one or more processor-based servers 100, preferably one or more web-based servers 100, configured to communicate with the database 130 and to generate proposals. As exemplary shown in FIG. 3, in accordance with an exemplary embodiment of the claimed invention, the server 100 comprises various proposal engines 400 to generate the proposals under the command and control of the server processor 110. These proposal engines 400 include but not limited to a criteria definer 410, an information gatherer 420, a unit inventory searcher 430, a unit selector 440, a reference locations or points of interest (POI) definer 450, a mapper 460, a proposal assembler 470, and a notification engine 490. The server 100 additional comprises a proposal viewer 480 to provide the client devices 200 access to the generated proposals.

The server processor 110 accesses and/or instructs the criteria definer 410 to define one or more criteria from which to select one or more outdoor advertising units, and the one or more outdoor advertising units can be suitable for implementing an advertising campaign associated with a buyer. The server processor 110 accesses and/or instructs the information gatherer 420 to define information related to the buyer and the advertising campaign. Meanwhile, the server processor 110 accesses and/or instructs the unit inventory searcher 430 to provide a selectable pool of outdoor advertising units from the multiple available outdoor advertising units based on the one or more criteria. The unit selector 440 is accessed and/or instructed by the server processor 110 to select the one or more outdoor advertising units from the selectable pool of outdoor advertising units. The reference locations definer 450 is accessed and/or instructed by the server processor 110 to define at least one reference location. The server processor 110 accesses and/or instructs the mapper 460 to map the one or more outdoor advertising units and the at least one reference location to a map. The proposal assembler 470 is accessed and/or instructed by the server processor 110 to assemble (a) the information related to the buyer and the advertising campaign, (b) the map, and (c) the one or more outdoor advertising units into a proposal. The proposal viewer 480, preferably, a graphical user interface (GUI), provides the client devices 200 access to proposals generated by the sever processor 110 over the communications network 300. The notification engine 490 provides provide notification of the generated proposal to one or more recipients over the communications network 300 via the connection facility 140.

In accordance with an exemplary embodiment of the claimed invention, the server processor 110, utilizing one or more proposal engines 400, generates a request for proposal (RFP) and/or one or more proposals (e.g., corresponding to the RFP). The proposal(s) can comprise one or more outdoor advertising units that satisfy one or more criteria provided by a buyer. Alternatively or in addition, the server processor 110 can locate (and/or provide as part of the proposal) one or more outdoor advertising units associated with one or more places of interest (e.g., provided by the buyer), such as, for example, one or more competing business establishments.

In accordance with an exemplary embodiment of the claimed invention, the server processor 110 utilizing one or more proposal engines 400 can generate the proposal for one or more sellers of outdoor advertising units, specifically, the server processor 110 transmits the proposal to client devices 200 associated with the sellers. The server processor 100 can generate RFPs and/or receive RFPs from a client device 200 associated with a buyer interested in implementing an advertising campaign. The sellers can access the server 100 over the communications network 300 using their client devices 200 to generate proposals in response to the RFP. It is appreciated that the sellers can receive the RFP directly on their client devices 200 over the communications network 300 via the connection facility 140 from the server 100 (e.g., via an Internet portal associated with system 1000) and/or indirectly through any suitable communication medium (e.g., electronic mail messaging, short message service text messaging, social network messaging, etc.).

In accordance with an exemplary embodiment of the claimed invention, the database 130 can be implemented as any suitable computer database (e.g., XML (Extensible Markup Language) database, MySQL database, and/or Oracle® database). The database 130 can aggregate (and/or store) data associated with multiple available outdoor advertising units and is organized in an efficient manner for querying and searching by the server processor 110. The multiple available outdoor advertising units (a) can be associated with one or more sellers of outdoor advertising systems and/or (b) can be managed by one or more third-party computer systems 500. Accordingly, in accordance with an exemplary embodiment of the claimed invention, the system 1000 can operate cooperatively and/or communicate with the third-party computer systems 500. Each third-party computer system 500 can manage one (or multiple) seller's contributions/shares of available outdoor advertising units to the multiple available outdoor advertising units. Each seller can own, lease, sell, and/or operate her respective available outdoor advertising units, and each of the available outdoor advertising units can be made available for inclusion in the proposals generated by the server processor 110. The database 130 can synchronize with one or more third-party computer system(s) 500 (e.g., periodically and/or in response to the occurrence of an event, such as, for example, upon generation of a request for an RFP by the server processor 110) to update and/or re-aggregate the multiple available outdoor advertising units. Exemplary multiple available outdoor advertising units can comprise multiple of (a) one or more available aerial advertising units, (b) one or more available billboard advertising units, (c) one or more available wall-scape advertising units, (d) one or more available digital video advertising units, (e) one or more available indoor signage advertising units, (f) one or more available mobile advertising units, (g) one or more available phone booth advertising units, (h) one or more available poster advertising units, (i) one or more available street furniture advertising units, (j) one or more available transit advertising units, and/or (k) one or more available urban panel advertising units.

In accordance with an exemplary embodiment of the claimed invention, the database 130 can also aggregate (and/or store) available outdoor advertising unit information related to each available outdoor advertising unit of the multiple outdoor advertising units. Exemplary available outdoor advertising unit information can comprise: (a) advertising campaign media types (e.g., aerial, billboard, wall-scape, digital video, indoor signage, mobile, telephone booth or call box, poster, street furniture (e.g., bus shelters), transit (e.g., moving objects), urban panel, alternative media formats, such as, for example, advertising at gas pumps and/or train and subway stations, etc.), (b) viewing direction (e.g., direction(s) (e.g., north, south, etc.) the available outdoor advertising unit faces), (c) related demographic information (e.g., age(s) of a target audience, income(s) of the target audience, etc.), (d) reach of the available outdoor advertising unit (e.g., defining an opportunity (e.g., a percentage chance) of the target audience to view the unit during an advertising campaign), (e) daily effective circulation (DEC) measurements, showing, latitude and longitude information, (f) illumination (e.g., whether the available outdoor advertising unit is illuminated), (g) identification number of the available outdoor advertising unit, (h) showing information, (i) region (e.g., state, county, city, etc.), (j) eyes on impression (EOI) measurements, etc. DEC measurements define the average number of persons potentially exposed to the available outdoor advertising unit over a period (e.g., 12 hours, or longer with illumination). Showing information is related to DEC measurements, and provides a definable level of delivery based on the population. EOI measurements define the average number of persons who are likely to notice an advertisement of an outdoor advertising unit.

In accordance with an exemplary embodiment of the claimed invention, the database 130 can also store criteria defined by the criteria definer 410 and/or information related to the buyer and the advertising campaign gathered by information gatherer 420. The criteria definer 410 and the information gatherer 420 are described in greater detail herein.

In accordance with an exemplary embodiment of the claimed invention, the server processor 110 accesses and queries the database 130 to retrieve information relating to a plurality of outdoor advertising units, including but not limited to, availability of the outdoor advertising unit, information relating to the outdoor advertising unit, condition or criteria established by owner/seller for leasing the outdoor advertising unit, buyer's information, buyer's advertising campaign requirements, as applicable, to generate one or more proposals. Alternatively or in addition, the server processor 110 communicates with the one or more third-party computer systems 500 and/or one or more computer systems 500 associated with the seller and/or buyer over the communications network 300 to access the databases associated with such computer systems.

The users (e.g., buyers and/or sellers) of system 1000 can directly access the server 100 to generate proposals using their client devices 200 over the communications network 300 via the connection facility 260. In accordance with an exemplary embodiment of the claimed invention, the system 1000 can be implemented as a centralized web based service/platform that manages the utilization of a plurality of outdoor advertising units for one or more sellers, and/or that generate one or more proposals for utilizing such outdoor advertising units, such as in response to a buyer's RFP(s) supporting an advertising campaign. Notwithstanding the manner in which the users of system 1000 access the proposal engine 400, the server processor 100 can facilitate the completion of the transactions, wherein the buyer is able to purchase outdoor advertising units in support of an advertising campaign. The server 100 and/or proposal engines 400 can be accessed by users over the communications network 300 via one or more graphical user interfaces on their client devices 200.

The connection facilities 140, 260 can comprise (a) one or more components configured to provide wired communication (e.g., one or more data buses, such as, for example, universal serial buses; one or more networking cables, such as, for example, coaxial cables, optical fiber cables, twisted pair cables; any other suitable data cable, etc.) and/or (b) one or more components configured to provide wireless communication (e.g., one or more radio transceivers, one or more infrared transceivers, etc.). The connection facilities 140, 260 can be configured to operate using any one or any combination of wired and/or wireless communication network topologies (e.g., ring, line, tree, bus, mesh, star, daisy chain, hybrid, etc.) and/or protocols (e.g., personal area network (PAN) protocols, local area network (LAN) protocols, wide area network (WAN) protocols, cellular network protocol(s), Powerline network protocols, etc.). Exemplary PAN protocols can comprise Bluetooth, Zigbee, Wireless Universal Serial Bus (USB), Z-Wave, etc.; exemplary LAN and/or WAN protocols can comprise Institute of Electrical and Electronic Engineers (IEEE) 802.3, IEEE 802.11, etc.; and exemplary wireless cellular network protocols can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc.

In accordance with an exemplary embodiment of the claimed invention, the criteria definer 410 defines (and/or stores in the database 130) one or more criteria from which to select one or more outdoor advertising units. Preferably, the criteria definer 410 receives the criteria from (a) a buyer, such as, for example, as an RFP and/or (b) from the sellers (e.g., separately from the RFP). The criteria definer 410 and/or the server processor 110 determines the suitability of outdoor advertising units for implementing an advertising campaign associated with the buyer. Alternatively or in addition, the criteria definer 410 receives additional criteria from the sellers that may be attractive to the buyer, though not necessarily required by or even known to the buyer. These additional criteria can be used as additional selling points for the proposals. In addition to the receiving the criteria, the server processor 110 and/or criteria definer 410 can also receive a name for the RFP, a name of the buyer, contact information for the buyer, and/or any additional comments the buyer has regarding the advertising campaign. In accordance with an exemplary embodiment of the claimed invention, the buyer can provide the criteria via one or more graphical user interfaces associated with the criteria definer 410 displayed on the user display 220 of her client device 200.

Exemplary criteria can comprise (a) a budget of the buyer, (b) an advertising campaign start date, (c) an advertising campaign end date, (d) a requested response date, (e) one or more advertising campaign regions (e.g., cities, counties, states, etc.), (f) one or more advertising campaign media types, and/or (g) other advertising campaign details. Other advertising campaign details can comprise any demographic information related to the target audience (e.g., gender, age range, income, residence, population), and any other desired metrics (e.g., viewing direction, illumination, DEC measurements, EOI measurements, reach, showing, identification numbers, tags, etc.) attractive to the buyer. For example, the buyer can be an automobile manufacturer, and the advertising campaign can be directed to the promotion of a vehicle manufactured by the automobile manufacturer. Accordingly, the target audience can be identified as males between the ages of 18-35 having an average income of approximately $60,000 and living in New York, New Jersey, or Connecticut. The one or more advertising campaign regions help to define the area or region within which the buyer would like to advertise. The population defines the number of persons living within the market area. The criteria can also comprise at least one place of interest (e.g., business establishments) to the buyer.

In accordance with an exemplary embodiment of the claimed invention, the POI definer 450 defines the places of interest (e.g., as provided by a buyer as part of an RFP). The POI definer 450 is also referred to herein as a references location definer 450, and the place(s) of interest can be referred to as reference location(s). The POI definer 450 receives the places of interest as locations designated on an interactive map by the user (e.g., a buyer) using the user input device 230 of her client device 200. The interactive map can be generated and displayed on the user display 220 of the client device 200 by the mapper 460. The buyer then selects the places of interest on the interactive map using the input device 230. The buyer can also establish ranges (e.g., a radius) around the places of interest as part of the place(s) of interest criteria.

In accordance with an exemplary embodiment of the claimed invention, the seller can access the unit selector 440 of the server 100 over the communications network 300 using her client device 200 to select one or more outdoor advertising units that meets the buyer's criteria. In utilizing the unit selector 440, the seller can reference the interactive map, displayed on her client device 200, including the places of interest and/or ranges for each of the places of interest designated by the buyer to select the appropriate outdoor advertising units from a selectable pool of outdoor advertising units, as described herein. The mapper 460 can map those available outdoor advertising units of the multiple available outdoor advertising units located within the ranges for each of the places of interest designated by the buyer on the sellers' client devices 200 to facilitate the sellers' ability to select the outdoor advertising units with the unit selector 460.

In accordance with an exemplary embodiment of the claimed invention, the server processor 110 is operable to utilize both the POI definer 450 and criteria definer 410 in defining the buyer's criteria for selecting one or more outdoor advertising units. For example, a buyer can define one or more coffee establishments as places of interest on the interactive map and establish an one mile range around each of the coffee shops. Thus, where the buyer competes with a coffee establishment, the seller can select one or more outdoor advertising units appropriate for competing with the coffee establishment (i.e., outdoor advertising units that are likely to target patrons of the competing coffee establishment).

In accordance with an exemplary embodiment of the claimed invention, the information gatherer 420 can define information related to the buyer and the advertising campaign. The information related to the buyer and the advertising campaign can be similar or identical to the criteria. The information gatherer 420 can receive the information related to the buyer and the advertising campaign data (e.g., via text boxes and/or fields of one or more graphical user interfaces associated with the information gatherer 420 displayed on the user's client device 200) from the buyer using her client device 200 to access the proposal engine 400 and/or from the database 130 (e.g., automatically populating the information based on the criteria stored at the database 130).

The unit inventory searcher 430 provides a selectable pool of outdoor advertising units from the multiple available outdoor advertising units based on the one or more criteria. In accordance with an exemplary embodiment of the claimed invention, the unit inventory searcher 430 applies the criteria against the multiple available outdoor advertising units and filters out those units that satisfy the criteria, such as, for example, by comparing the criteria to the available outdoor advertising unit information. Thus, the selectable pool of outdoor advertising units can comprise outdoor advertisement units appropriate for the advertising campaign. That is, the unit selector 430 selects one or more outdoor advertising units from the selectable pool of outdoor advertising units, such as, for example, as provided for (e.g., selected) by the seller using her client device 200 to access the proposal engine 400. In accordance with an exemplary embodiment of the claimed invention, the unit inventory searcher 430 dynamically displays the selectable pool of outdoor advertising units on the user display 220 of the seller's client device 200 from which the seller can select the one or more outdoor advertising units on her client device 200 using the unit selector 440. The unit inventory searcher 430 can provide on the display 220 of seller's client device 200 a viewable picture of the outdoor advertising unit, a location of the outdoor advertising unit, and/or a description of the outdoor advertising unit for each of the outdoor advertising units of the selectable pool of outdoor advertising units to aid the seller in selecting the outdoor advertising units on the client device 200 with unit selector 440. Preferably, the selectable pool of outdoor advertising units are dynamically displayed on the interactive map on the user display 220 of the seller's client device 200. Upon selecting one of the potential outdoor advertising units from the selectable pool of outdoor advertising units, the seller can view on the display 220 of her client device 200 the viewable picture, location, and/or description of the outdoor advertising unit. Alternatively or in addition, the unit selector 440 is automated to select the outdoor advertising units as opposed to the seller manually selecting the outdoor advertising units.

In accordance with an exemplary embodiment of the claimed invention, the mapper 460 maps the outdoor advertising units and/or the at least one place of interest to an interactive map displayed on the user display 220 of the client device 200. Preferably, the mapper 460 displays the proximity of the places of interest in relation to the outdoor advertising units to be included within a proposal generated by the server processor 110 on the interactive map displayed on the client device 200. The mapper 460 also generates and displays an interactive map on the user display 220 of the buyer's client device 200 from which the buyer can select the places of interest by accessing the POI definer 450 using her client device 200. The interactive map used to select the places of interest can be the same interactive map upon which the mapper 460 maps the outdoor advertising units.

In accordance with an exemplary embodiment of the claimed invention, the proposal assembler 470 assembles (a) the information related to the buyer and the advertising campaign, (b) the map, and/or (c) the one or more outdoor advertising units into a proposal. After the seller selects the available outdoor advertising units on the seller's client device 200 using the unit selector 440 to include in the proposal, the proposal assembler 470 assembles the proposal. In addition to (a) the buyer related and advertising campaign information, (b) the map, and/or (c) the one or more outdoor advertising units, the proposal assembler 470 can also include other suitable information in the proposal. For example, the proposal assembler 470 can include in the proposal any of the criteria (e.g., the budget of the buyer), a total property cost for the outdoor advertising units over the duration of the advertising campaign (e.g., as defined by the advertising campaign start date and end date), an installation cost for the outdoor advertising units, a total cost of the outdoor advertising units included in the proposal (e.g., such that the buyer is able to compare the total cost to the budget of the buyer), etc. The sellers can access the proposal viewer 480 with their client devices 200 to view the viewable pictures, locations, and/or descriptions of the outdoor advertising units associated with the proposal. In accordance with an exemplary embodiment of the claimed invention, the proposal assembler 470 can also assemble the RFP provided by the buyer via her client device 200 over the communications network 300.

In accordance with an exemplary embodiment of the claimed invention, the proposal viewer 480 provide access to the proposal (e.g., to the buyer and/or the sellers). For example, after proposal assembler 470 assembles the proposal, the proposal viewer 480 can make the proposal available to one or more intended recipients, such as, for example, via an Internet portal associated with system 1000. For example, the buyer and/or sellers using their respective client device 200 can access the server 100 or a service provider's website including the proposal and located at the Internet portal by activating a unique link associated with the Internet website and providing access to the website. Preferably, the server processor 100 aggregates the proposals and any subsequently generated proposals for a given RFP into a unified proposal. For example, each time a seller responds to a buyer's RFP, the notification engine 490 notifies the buyer via her client device 200, e.g., the notification engine 490 transmits a text or an email to the buyer and the server processor 100 integrates the seller's proposal into a single proposal (rather than multiple separate proposals). In accordance with an exemplary embodiment of the claimed invention, the buyer can use her client device 200 to access the proposal viewer 480 over the communications network 300 to select and view any specific seller's proposal from the unified proposal stored in the database 130. Preferably, the proposal viewer 480 also provides the client devices 200 access to the RFPs stored in the database 130.

In accordance with an exemplary embodiment of the claimed invention, the notification engine 490 provides notification of the RFP and/or the proposal to one or more interested recipients, e.g., buyers and/or sellers, on the notification list. Preferably, the notification engine 490 provides notification of the proposal to the recipients' client devices 200 via any suitable communication mechanism (e.g., electronic mail messaging, short message service (SMS) text messaging, social network messaging (e.g., a message board), etc.). Alternatively or in addition, the user can use her client device 200 to access the notification engine 490 over the communications network 300 to place herself or a recipient on the notification list. That is, the user can utilize one or more graphical user interfaces (GUIs) associated with the notification engine 490 displayed on her client device 200 to place herself or an intended recipient on the notification list by entering her information on the GUI displayed her client device 200 using the input device 230. For example, the seller can enter an electronic mail address of the intended recipient of the proposal (e.g., buyer@company.com and/or buyer2@company.com) on the GUI associated with the notification engine 490 displayed on her client device 200. Also, the notification engine 490 can include a personal message in the notification message by providing a text box or field on the GUI displayed on the user display 220 for entering the personal message by the user using the input device 230. In accordance with an exemplary embodiment of the claimed invention, the notification engine 490 only permits the seller to designate buyers having submitted RFPs as recipients. Alternatively, the notification engine 490 permits the seller to designate any buyers as recipients even if the buyer did not submit a RFP.

In accordance with an exemplary embodiment of the claimed invention, the notification engine 490 automatically provides an unique link (and the personal message, when applicable) of the proposal to the recipients' client devices 200 via the relevant communication mechanisms. The notification engine 490 delivers the notification message, along with personal message if provided, to the client devices 200 of the specified and intended recipients. By clicking on the unique link, the server processor 110 connects the recipient's client device 200 to the server 100 or a secure website of the service provider displaying the seller's proposal.

In accordance with an exemplary embodiment of the claimed invention, the server processor 110 can process a transaction between the buyer and one or more sellers for one or more outdoor advertising units. That is, if the buyer is satisfied with the terms of the proposal, the buyer can indicate her acceptance of the proposal using one or more graphical user interfaces associated with the server processor 110 displayed on display 220 of her client device 200.

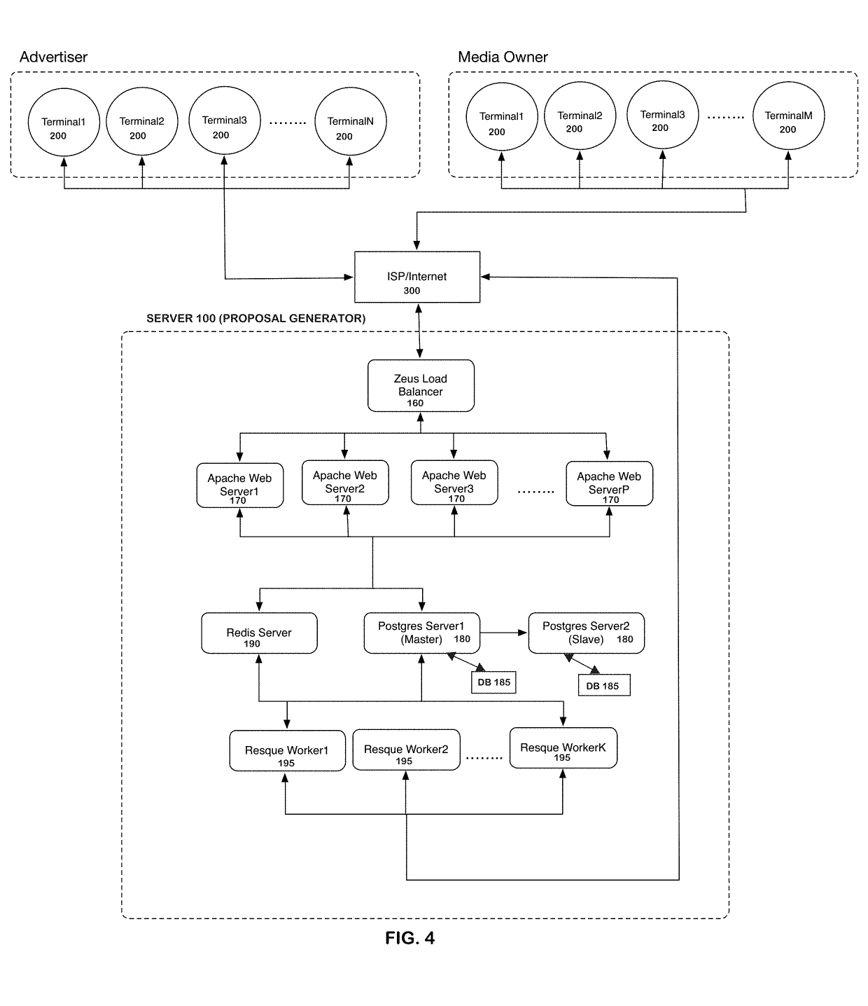

Turning now to FIG. 4, there is illustrated a schematic diagram of an exemplary system 1000 utilized in generating a proposal in accordance an exemplary embodiment of the claimed invention. The server processor 110 activates one or more proposal engines 400 to enable the seller/multimedia owner (collectively referred to as the “multimedia owner”) to propose one or more outdoor units to the buyer/advertiser/agency (collectively referred to herein as the “advertiser”) based on the advertiser's criteria previously established through the system 1000 and sent to the multimedia owner. The advertiser initiates a hypertext transfer protocol (“HTTP”) request from her client device 200 by entering the uniform resource locator (“URL”) of the server 100, preferably the URL of the server's proposal generator, in a web browser displayed on the user display 220 of her client device 200. The advertiser's HTTP request is transported over the communications network 300 (e.g., Internet) using a transmission control protocol (“TCP”) protocol to the server 100.

The server processor 110 directs the load balancer 160, preferably the Zeus load balancer 160, to decode and forward the incoming HTTP request to the appropriate web server 170, preferably Apache web server 170. The recipient Apache web server 170 decodes the advertiser's HTTP request and requests data from a postgres server 180. The server processor 110 stores the advertiser's HTTP request in the memory 120 and/or the database 185 associated with the postgres server 180. It is appreciated that the two postgres servers 180 are in master/slave configuration and the recipient Apache web server 170 requests data from the master postgres server 180.

In accordance with an exemplary embodiment of the claimed invention, the recipient Apache server 170 generates an appropriate hypertext markup language (“HTML”) template, e.g., GUI associated with the criteria definer 410, to be displayed on the display 220 of the advertiser's client device 200. That is, the server processor 110 activates the criteria definer 410 and transmits/transports the HTML template to the advertiser's client device 200 as an HTTP response over the communications network 300 using the TCP protocol via the connection facility 140. Also, the server processor 110 stores the HTML template in the memory 120 and/or the database 185.

The client processor 210 of the advertiser's client device 200 stores the received HTML template in the memory 240 and/or the storage device 250, and displays the received HTML template in a web browser of the advertiser's client device 200 to be viewed by the advertiser. The advertiser initiates an HTTP request from her client device 200 by entering information relating to one or more advertising campaign requirements to populate the HTML template using the input device 220 or the touch screen 220. Preferably, the client processor 210 stores the entered information and the HTTP request comprising the campaign requirements data in the memory 240 and/or storage device 250. The client processor 210 transmits/transports the HTTP request comprising the campaign requirements data to the server 100 over the communications network 300 using the TCP protocol via the connection facility 260.

The server 100 and/or the server processor 110 receives the advertiser's HTTP request comprising the campaign requirements data from the client device 200. The server processor 110 stores the received HTTP request comprising the campaign requirements data in the memory 120 and/or the database 185. The server processor 110 directs the load balancer 160, preferably the Zeus load balancer 160, to decode and forward the incoming HTTP request comprising the campaign requirements data to the appropriate web server 170, preferably Apache web server 170. The recipient Apache web server 170 decodes the advertiser's HTTP request comprising the campaign requirements data and transports/transmits the resultant or extracted data from the advertiser's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 180 generates asynchronous Resque jobs to send emails to multimedia owners and pull data (e.g., demographic and media ratings, etc.) from external web application program interfaces (APIs) by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client devices 200 associated with the multimedia owners over the communications network 300 using the simple mail transfer protocol (“SMTP”) protocol.

In accordance with an exemplary embodiment of the claimed invention, multimedia owners receive these emails on their client devices 200 and can initiate HTTP requests from their client devices 200 by entering the URL of the server 100, preferably the URL of the server's proposal generator, in a web browser displayed on their user displays 220 of their client devices 200. The multimedia owners' HTTP requests are transported/transmitted over the communications network 300 using the TCP protocol to the server 100.

The server processor 110 directs the Zeus load balancer 160 to decode and forward the incoming HTTP request to the appropriate Apache web server 170. The recipient Apache web server 170 decodes each media owner's HTTP request and requests data from the master postgres server 180. The server processor 110 stores the multimedia owners' HTTP requests in the memory 120 and/or the database 185 associated with the master postgres server 180.

In accordance with an exemplary embodiment of the claimed invention, the recipient Apache server 180 generates an appropriate HTML template to be displayed on the display 220 of the multimedia owners' client devices 200. The server processor 110 transmits/transports the HTML template to the multimedia owners' client device 200 as an HTTP response over the communications network 300 using the TCP protocol via the connection facility 140. Also, the server processor 110 stores the HTML template in the memory 120 and/or database 185.

The client processor 210 of the multimedia owners' client device 200 stores the received HTML template in the memory 240 and/or the storage device 250, and displays the received HTML template in a web browser of the multimedia owners' client devices 200 to be viewed by the respective multimedia owner. Each multimedia owner can initiate a HTTP request from her client device 200 by entering information relating to her proposal to populate the HTML template using the input device 220 or the touch screen 220. Preferably, the client processor 210 stores the entered information and the HTTP request comprising data relating to the proposal in the memory 240 and/or the storage device 250. The client processor 210 transmits/transports the HTTP request comprising data relating to the proposal to the server 100 over the communications network 300 using the TCP protocol via the connection facility 260.

The server 100 and/or the server processor 110 receives the multimedia owner's HTTP request comprising data relating to the proposal from her client device 200. The server processor 110 stores the received HTTP request comprising data relating to the proposal in the memory 120 and/or the database 185. The server processor 110 directs the Zeus load balancer 160 to decode and forward the incoming HTTP request comprising data relating to the proposal to the appropriate Apache web server 170. The recipient Apache web server 170 decodes each multimedia owner's HTTP request comprising data relating to her proposal and transports/transmits the resultant or extracted data from the multimedia owner's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 180 generates asynchronous resque jobs to send emails to the advertiser and pull data from external web APIs by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client device 200 associated with the advertiser over the communications network 300 using the SMTP protocol.

In accordance with an exemplary embodiment of the claimed invention, the advertiser receives these emails on her client device 200 and can initiate one or more HTTP requests for various operations described herein from her client device 200 as described herein by entering the URL of the server 100, preferably the URL of the server's proposal generator, in a web browser displayed on their user displays 220 of their client devices 200. The advertiser's HTTP requests are transported/transmitted over the communications network 300 using the TCP protocol to the server 100.

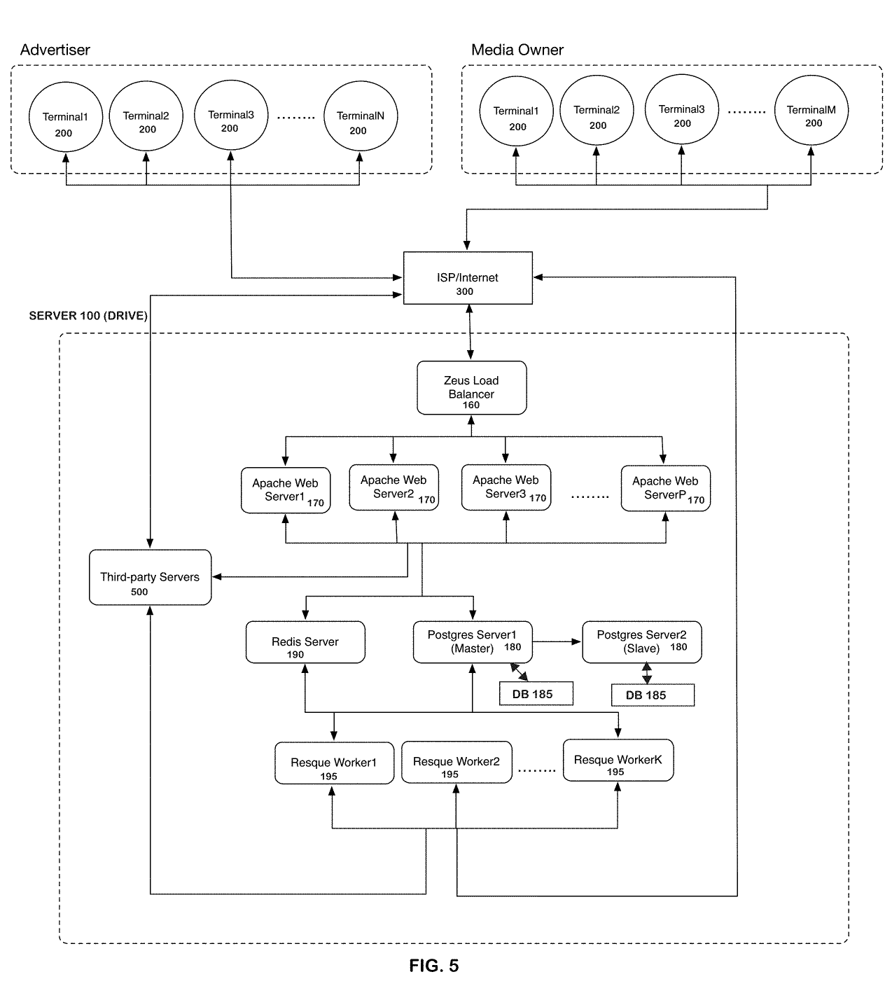

Turning now to FIG. 5, there is illustrated a schematic diagram of an exemplary system 1000 utilized in selecting outdoor units for purchase in accordance an exemplary embodiment of the claimed invention. The server processor 110 activates one or more proposal engines 400 to enable the advertiser to select one or more outdoor units for purchase and send a purchase request to the appropriate multimedia owner. The advertiser initiates a HTTP request from her client device 200 by entering the URL of the server 100, preferably the URL of the server's drive, in a web browser displayed on the user display 220 of her client device 200. The advertiser's HTTP request is transported over the communications network 300 using the TCP protocol to the server 100.

The server processor 110 directs the Zeus load balancer 160 to decode and forward the incoming HTTP request to the appropriate Apache web server 170. The recipient Apache web server 170 decodes the advertiser's HTTP request and generates Resque jobs to pull data (e.g., demographic and media ratings, etc.) from the third-party servers 500 by sending configuration options in the form of keys to the Redis server 190. The Resque jobs execute synchronously and pull relevant data from the third-party servers 500 over the communications network 300 using the TCP protocol. The recipient Apache web server 170 also requests data from the master postgres server 180 to populate an HTML template. The server processor 110 transmits/transports the HTML template to the advertiser's client device 200 as an HTTP response over the communications network 300 using the TCP protocol via the connection facility 140. Also, the server processor 110 stores the advertiser's HTTP request and the HTML template in the memory 120 and/or the database 185 associated with the master postgres server 180.

The client processor 210 of the advertiser's client device 200 stores the received HTML template in the memory 240 and/or the storage device 250, and displays the received HTML template in a web browser of the advertiser's client device 200 to be viewed by the advertiser. The advertiser initiates an HTTP request from her client device 200 by entering information relating to one or more outdoor units interested in purchasing to populate the HTML template using the input device 220 or the touch screen 220. Preferably, the client processor 210 stores the entered information and the HTTP request comprising the purchasing information in the memory 240 and/or storage device 250. The client processor 210 transmits/transports the HTTP request comprising the purchasing information to the server 100 over the communications network 300 using the TCP protocol via the connection facility 260.

The server 100 receives the advertiser's HTTP request comprising the purchasing information from the client device 200. The server processor 110 stores the received HTTP request comprising the purchasing information in the memory 120 and/or the database 185. The server processor 110 directs the Zeus load balancer 160 to decode and forward the incoming HTTP request comprising the purchasing information to the appropriate Apache web server 170. The recipient Apache web server 170 decodes the advertiser's HTTP request comprising the purchasing information and transports/transmits the resultant or extracted data from the advertiser's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 170 generates asynchronous Resque jobs to send emails to multimedia owners and pull data (e.g., demographic and media ratings, etc.) from the third-party servers 500 by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client devices 200 associated with the multimedia owners over the communications network 300 using the SMTP protocol.

In accordance with an exemplary embodiment of the claimed invention, multimedia owners receive these emails on their client devices 200 and can initiate HTTP requests from their client devices 200 by entering the URL of the server 100, preferably the URL of the server's drive, in a web browser displayed on their user displays 220 of their client devices 200. The multimedia owners' HTTP requests are transported/transmitted over the communications network 300 using the TCP protocol to the server 100.

The server processor 110 directs the Zeus load balancer 160 to decode and forward the incoming HTTP request to the appropriate Apache web server 170. The recipient Apache web server 170 decodes each media owner's HTTP request and requests data from the master postgres server 180. The server processor 110 stores the multimedia owners' HTTP requests in the memory 120 and/or the database 185 associated with the master postgres server 180.

In accordance with an exemplary embodiment of the claimed invention, the recipient Apache server 180 generates an appropriate HTML template to be displayed on the display 220 of the multimedia owners' client devices 200. The server processor 110 transmits/transports the HTML template to the multimedia owners' client device 200 as an HTTP response over the communications network 300 using the TCP protocol via the connection facility 140. Also, the server processor 110 stores the HTML template in the memory 120 and/or database 185.

The client processor 210 of the multimedia owners' client device 200 stores the received HTML template in the memory 240 and/or the storage device 250, and displays the received HTML template in a web browser of the multimedia owners' client devices 200 to be viewed by the respective multimedia owner. Each multimedia owner can initiate a HTTP request from her client device 200 by entering information relating to availability of the outdoor units desired by the advertiser to populate the HTML template using the input device 220 or the touch screen 220. Preferably, the client processor 210 stores the entered information and the HTTP request comprising data relating to the outdoor units' availability in the memory 240 and/or the storage device 250. The client processor 210 transmits/transports the HTTP request comprising data relating to the outdoor units' availability to the server 100 over the communications network 300 using the TCP protocol via the connection facility 260.

The server 100 and/or the server processor 110 receives the multimedia owner's HTTP request comprising data relating to the outdoor units' availability from her client device 200. The server processor 110 stores the received HTTP request comprising data relating to the outdoor units' availability in the memory 120 and/or the database 185. The server processor 110 directs the Zeus load balancer 160 to decode and forward the incoming HTTP request comprising data relating to the outdoor units' availability to the appropriate Apache web server 170. The recipient Apache web server 170 decodes each multimedia owner's HTTP request comprising data relating to the outdoor units' availability and transports/transmits the resultant or extracted data from the multimedia owner's HTTP request to the master postgres server 180. The master postgres server 180 stores the resultant or extracted data in its persistent storage device or database 185. Preferably, another or slave postgres server 180 also stores the resultant or extracted data in its persistent storage device or database 185 to provide redundancy.

In accordance with an exemplary embodiment of the claimed invention, the recipient Apache web server 170 generates asynchronous resque jobs to send emails to the advertiser and pull data from the third-party servers 500 by sending configuration options in the form of keys to the Redis server 190. The Resque Workers 195 poll the Redis Server 190 to retrieve the relevant keys. The Resque Workers 195 perform the predefined jobs in accordance with the relevant keys and generate/transmit emails to the client device 200 associated with the advertiser over the communications network 300 using the SMTP protocol.

In accordance with an exemplary embodiment of the claimed invention, the advertiser receives these emails on her client device 200 and can initiate one or more HTTP requests for various operations described herein from her client device 200 as described herein by entering the URL of the server 100, preferably the URL of the server's drive, in a web browser displayed on their user displays 220 of their client devices 200. The advertiser's HTTP requests are transported/transmitted over the communications network 300 using the TCP protocol to the server 100.

In accordance with an exemplary embodiment of the claimed invention, the server processor 110 generates a mathematically optimized Out of Home Media (OOH) purchasing recommendation to meet campaign goals of the client/buyer. OOH is all media formats specifically intended to reach the consumers outside their home. The server processor 110 considers the inventory's availability for purchase, geolocation, price, media format, average audited Impressions, as well as the campaign budgets, target rating points (TRPs) goals, and an inventory quality coefficient (IQC) calculated from Inventory metadata and advertiser-supplied parameters.

The proposal viewer 480 allows advertisers to view all Inventory in proposals generated by system on behalf of the vendors in one unified map, detail, and grid view. Along with many other functions, the proposal viewer 480 allows advertisers to hide and like inventory and save the current state of the inventory in the campaign as a scenario which can be used to recommend which subset of the proposed Inventory from all proposals should be purchased by the client/buyer to meet their campaign goals, and deliver the most number of impressions, weighted by an inventory quality coefficient, to their target audience. The server processor 110 can generate many scenarios for a single campaign, representing different options for the client. These scenarios can be saved and viewed at a later date using the proposal viewer 480 or on the client device 200 over the network 300 via a secure link to the server 100 over the network 300. Scenarios may also be copied, removed, and edited by an advertiser.

In accordance with an exemplary embodiment of the claimed invention, the server processor 110 algorithmically generates an OOH media campaign plan recommendation as follows:

1. An advertiser initiates an HTTP (HyperText Transfer Protocol) request from their terminal 200 by entering the proposal viewer URL in a web browser.

2. The HTTP request is transported over the Internet 300 using the TCP protocol (Transmission Control Protocol).

3. The HTTP request is received by the proposal viewer 480.

4. A load balancer 180 decodes the incoming HTTP request and forwards it to an appropriate Apache Web Server 170.

5. The recipient Apache Web Server 170 decodes the HTTP request by executing relevant code.

6. The Apache Web Server 170 requests data from a Postgres Server (Master) 180.

7. The Apache Web Server 170 uses data from the Postgres server 180 to populate an HTML (HyperText Markup Language) template.

8. The HTML template is transported as an HTTP response over the Internet 300 using the TCP protocol.

9. The HTTP response is received by the advertiser's terminal 200.

10. The advertiser views the template in a web browser on their terminal 200.

11. Additional HTTP requests are made by the JavaScript code on the advertiser's web browser asynchronously, repeating steps 4-6

12. The Apache Web Server 170 uses data from Postgres server 180 to generate JSON (JavaScript Object Notation) content.

13. The JSON content is transported as an HTTP response over the Internet 300 using the TCP protocol.

14. The JavaScript code interprets the JSON data and renders parts of the view in response.

15. The advertiser clicks on a button on their terminal display 220 which instructs the server processor 110 to open a model containing a User Interface for the Algorithmic Campaign Inventory Optimizer.

16. The advertiser can select optimization criteria.

17. The server processor 100 executes the optimizer using a Knapsack Problem Algorithm (depending on criteria, the optimizer may run one of several variations) and returns the result in the form of the Inventory selected to best meet optimization criteria. Knapsack Problem Algorithm is an algorithm that maximize the value to fit within the constraint or the selected optimization criteria.

18. The result is displayed as a summary view in the terminal display 220.

19. The advertiser can select preview plan and view the result on a map view using the mapper 460.

20. The advertiser can use the user interface display on their terminal display 220 to save the result as a new Out of Home Media Campaign Plan Recommendation (Scenario) or apply to the current Scenario currently loaded into proposal viewer 480.

21. The Scenario data to be saved is transported via HTTP request over the Internet 300 using the TCP protocol.

22. This HTTP request is received by the server 100 for scenario creation.

23. A load balancer 160 decodes the incoming HTTP request and forwards it to an appropriate Apache Web Server 170.

24. The recipient Apache Web Server 170 processes the incoming request by executing relevant code.

25. The resulting data is transported over to a Postgres Server (Master) 180 that persists the data inside a database 185 stored on a disk.

26. This data is replicated over to another Postgres Server (Slave) 180.

From proposal viewer 480, an advertiser clicks on the pilot button which displays the Pilot modal dialog on the terminal display 220 to initiate the generation of an OOH media campaign plan recommendation by the server processor 110. In accordance with an exemplary embodiment of the claimed invention, the modal dialog includes the campaign title on the top, options and parameters for the optimizer on the left, and a summary view on the right which displays output from the optimization.

The advertiser/user fills out their parameters. As they change the parameters, a summary output from the recommendation engine is displayed on the right summary pane.

In the preview pane, the user sees a map view with the selected units shown. The user may go back to the start screen and change parameters or progress by outputting the result as a scenario. Either overwriting the existing scenario loaded in proposal viewer 480 or create a new scenario. If the new scenario option is selected, the user enters a title and description for the new scenario. The proposal viewer reflects the applied scenario in the relevant market.

The server processor 110 utilizes the 0-1 Knapsack Problem Dynamic Programming Algorithm to maximize the inventory quality coefficient weighted impressions (IQCIs) while staying within an advertiser's or buyer's budge ceiling. As noted herein IQCIs is the inventory quality coefficient (IQC) multiplied by impressions. Alternatively, the server processor 110 utilizes the 0-1 Knapsack Problem Dynamic Programming Algorithm to maximize IQCIs while staying within the target rating points (TRPs) or impressions ceiling if the advertiser wants to see what an optimal plan would look like and cost for a TRPs or Impressions goal.

The “0-1” component of the Knapsack Problem Dynamic Programming Algorithm means that the inventory used by the algorithm cannot be split as pricing is not usually linear (e.g., 1 week price is not equal to 10 week price divided by 10) and vendors/sellers are not always willing to sell their inventory for arbitrary lengths of time in the availability period (e.g., 3 days may not be an option). Vendors can propose the same Inventory as separate line items with distinct flight dates and pricing to be included as distinct opportunities to buy. The server processor 110 can use additional Knapsack algorithms to allow splitting of the values (i.e., inventory) if allowed by the vendor.

In the algorithm, the number xᵢ of each Inventory is restricted to zero or one. Given a set of n items numbered from 1 up to n, each with a weight wᵢ and a value vᵢ, along with a maximum weight capacity W,

$${\sum }_{i = 1}^{n} {υ}_{i} {x}_{i} maximize subject {\sum }_{i = 1}^{n} {w}_{i} {x}_{i} \leq W to {x}_{i} ∈ \{ 0 , 1 \} and$$

Informally, the problem is to maximize the sum of the values of the items in the Knapsack so that the sum of the weights is less than or equal to the Knapsack capacity.

In accordance with an exemplary embodiment of the claimed invention, the server processor 110 assigns the parameters in the following way:
values=Price for each Inventory matching filters
weights=IQCIs for each Inventory matching filters
   capacity=Budget ceiling
      or
   values=TRPs for each Inventory matching filters
   weights=IQCIs for each Inventory matching filters
      capacity=TRPs ceiling

### Optimizer Options

| | |
|---|---|
| Market | Only include Inventory that is in a specific Market. |
| Media Format | Only include inventory that matches a specific media |
| | format Filter (e.g. Bulletins and Wallscapes) |
| Mode | Budget ceiling or TRPs ceiling |
| Other Options | Example: optionally exclude Inventory already hidden |
| | (disliked) by the Advertiser. |
| IQC Settings | Adjust the IQC parameters. |

As noted herein, an inventory quality coefficient (IQC) is a non-negative number which can be multiplied with values being used for the purposes of weighting for optimization or sorting to give a measure of quality.

In accordance with an exemplary embodiment of the claimed invention, an IQC is derived from the weighted arithmetic mean of a set of quality coefficients (QCs) and importance scores. Importance scores default to 1 (no weight) for any quality coefficients assigned to an attribute or computed value (metric). However, an advertiser may adjust the definitions for QCs and the importance score when running optimizations.

Metrics can be advertiser defined (e.g., a subjective “wow-factor” score), an attribute (e.g., direction the ad is facing), or system provided (e.g., distance to closest POI).

An example of a QC definition (configurable by an advertiser) is shown below for a Distance to closest POI metric:
Distance to closest POI
   <0.02 miles=1.5
   <0.1 miles=1.2
   >0.4 miles=0.8

Additionally, the advertiser may decide that the importance of this metric is high for their campaign and assign it an importance score of 10 (the number isn't important)

For illustration purposes, we have assumed that the advertiser is using the following attributes and their QCs have been computed for a particular inventory, as shown in Table 1. Additionally, the advertiser has set a relative importance score for each attribute to be used when calculating the IQC.

TABLE 1

| Metric | QC | Importance |
|---|---|---|
| Distance to closest POI | 1.2 | 10 |
| Distance to subway | 0.8 | 3 |
| Media Format | 1.1 | 5 |
| Liked previously | 1.1 | 8 |
| Proximity to traffic light | 0.9 | 2 |

The server processor 110 utilizes the values in Table 1 to calculate the IQC for the optimization. For this case, the server processor calculates the following result:

(10*1.2+3*0.8+5*1.1+8*1.1+2*0.9)/(10+3+5+8+2)=1.08928571

Therefore, the inventory quality coefficient for the values in Table 1 would be 1.08928571. This IQC would weigh the quality of this inventory slightly higher than normal based on the metrics definitions and relative importance scores assigned by the advertiser.

### EXAMPLES

The claimed system can generate optimized scenarios, for given parameters and Table 2 of Inventory proposed for a campaign in a market along with IQCs calculated using advertiser metric definitions and relative importance scores, as noted herein. Further, summary data can be shown in addition to the examples below, for example, the weighted average quality for the generated scenario or other metrics about the scenario.

TABLE 2

| Inventory ID | Price | Impressions | IQC |
|---|---|---|---|
| A | $1,375 | 250,788 | 1.2 |
| B | $300 | 28,590 | 1 |
| C | $300 | 20,738 | 0.75 |
| D | $450 | 33,515 | 0.25 |
| E | $637 | 73,931 | 1.25 |
| F | $375 | 11,358 | 2.1 |

Inventory ID: a unique identifier for the inventory as proposed; Price: price for the inventory for a specified period; Impressions: the total number of time people are likely to notice an ad; and IQC: pre-calculate for this example.

### Scenario 1

Input and Generated Scenario (simplified)

| | |
|---|---|
| Budget | $1,200 |
| Use IQS | No |
| Optimize for | Impressions |
| Scenario Cost | $1,087 |
| Scenario Inventory | D, E |
| Impressions | 107,446 |
| CPM | $10.12 |

### Scenario 2

Input and Generated Scenario (simplified)

| | |
|---|---|
| Budget | $1,200 |
| Use IQS | Yes |
| Optimize for | Impressions |
| Scenario Cost | $937 |
| Scenario Inventory | B, E |
| Impressions | 102,521 |
| CPM | $9.14 |

After an Out of Home Media Campaign Plan Recommendation (scenario) has been generated by the server processor 110, an advertiser may leverage a radar function of the system which enables connectivity and utilization of real time and dynamic data sources such as social, mobile tracking, or customer orders to enable real time updates to IQCs providing insights into the campaign before, during, and after the campaign is active.

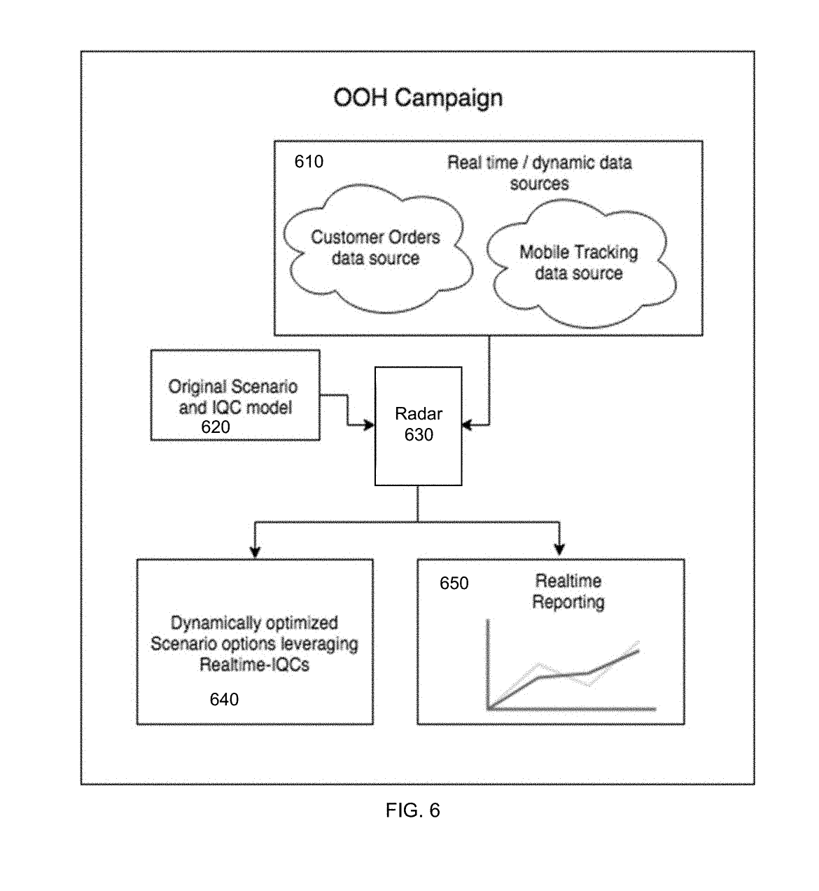

Turning now to FIG. 6, in accordance with exemplary embodiment of the claimed invention, the radar 630 enables the server processor 110 to track changes in IQCs for the inventory in a campaign as new data 610 is collected (Realtime-IQCs) as well as additional available inventory in the market and presents new dynamically updated scenario options 640 to the advertiser. This enables the system to optimize the campaign placements prior to campaign activation by the advertise and/or to optimize up until the creative due date for non-digital (traditional) inventory or during an active campaign for a digital inventory.

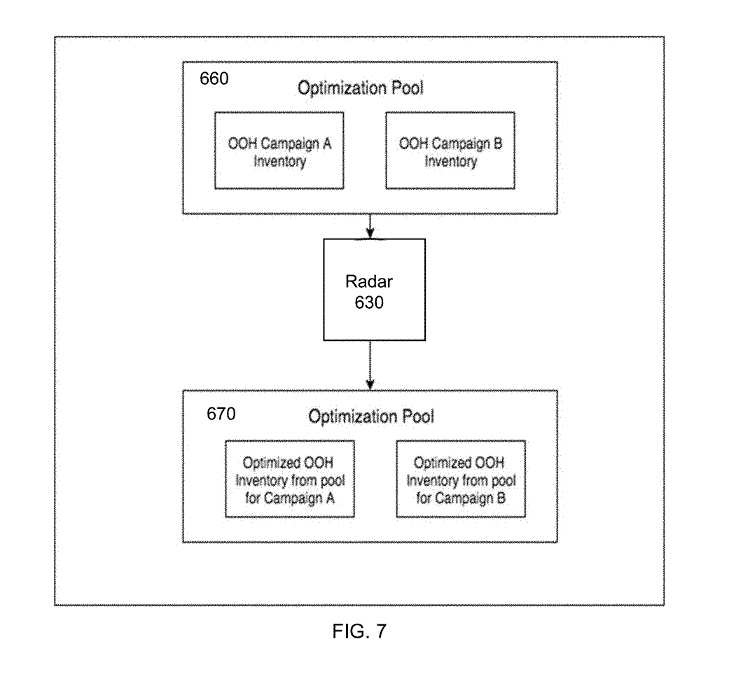

Additionally, as shown in FIG. 7, the radar 630 allows the advertiser to add multiple campaigns to an optimization pool 660, 670 which enables the server processor 110 to use Realtime-IQCs to algorithmically suggest optimized exchanges of already-contracted inventory between the campaigns to deliver against the target audience and other parameters for each campaign most effectively.

Additionally, during a campaign, the server processor 110 accesses and pipes real time or dynamic data 610 for attribution or other measurement such as a dataset of mobile device locations or customer orders into the radar 630 to provide real time metrics and reporting 650, such as how well the inventory is delivering against the campaign goals, e.g. increase in store visits.

This data is stored along with all other data related to the campaign and the Pilot recommendations in a data model library 130 which is used by the server processor 110 for future campaigns to suggest IQC metrics and weightings using machine-learning techniques, constantly improving the algorithms automatically over time.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system to dynamically generate, monitor and optimize an advertising campaign, comprising:
a database aggregating an inventory of available outdoor advertising units for purchase from a plurality of multimedia owners;
a plurality of processor-based client devices, each client device is associated with an advertiser or a multimedia owner;
a communications network;
a processor-based server processes requests received from the client devices over said communications network, and comprises:
a load balancer to decode the requests from said plurality of client devices, and transports responses to said plurality of client devices; and
a server processor configured to:
generate the advertising campaign comprising one or more outdoor advertising units selected based on a campaign budget of the advertiser, target rating point goal, a geolocation, a price, a media format, average audited impressions and an inventory quality coefficient of each outdoor advertising unit in the inventory of available outdoor advertising units for purchase;
monitor availability of previously unavailable outdoor advertising units, and update the inventory of available outdoor advertising units for purchase;
track real-time changes to the inventory quality coefficient for said each outdoor advertising unit in the updated inventory of available outdoor advertising units for purchase to provide an updated inventory quality coefficient for said each outdoor advertising unit in the updated inventory of available outdoor advertising units for purchase; and
dynamically update and optimize the advertising campaign based on the updated inventory quality coefficient of said each outdoor advertising unit in the updated inventory of available outdoor advertising units for purchase.

2. The system of claim 1, wherein the server processor determines the inventory quality coefficient of said each outdoor advertising unit from a weighted arithmetic mean of a set of quality coefficient derived from metadata or metrics of said each outdoor advertising unit.

3. The system of claim 1, wherein the media format of said each outdoor advertising unit is a digital or non-digital outdoor advertising unit; and wherein the server processor is configured to dynamically update and optimize an active advertising campaign for an inventory of digital outdoor advertising units.

4. The system of claim 1, wherein the media format of said each outdoor advertising unit is a digital or non-digital outdoor advertising unit; and wherein the server processor is configured to dynamically update and optimize prior to an activation of the advertising campaign for an inventory of non-digital outdoor advertising units.

5. The system of claim 1, wherein the processor-based server further comprises:
a plurality of web servers to process the requests, extract data from the requests and generate a response to each request; and
at least one postgres server stores extracted data received from said plurality of web servers and provides stored data to said plurality of web servers.

6. The system of claim 1, further comprising two postgres servers in a master and slave configuration.

7. The system of claim 1, wherein the postgres server comprises a persistent storage device or a database.

8. The system of claim 1, wherein the responses are HTML templates.

9. The system of claim 5, wherein a request comprises an HTML template populated with information by an advertiser or a multimedia owner.

10. The system of claim 1, wherein said plurality of web servers are configured to generate Resque jobs.

11. The system of claim 10, further comprising a Redis server that associates a key to each Resque job.

12. The system of claim 11, wherein each Resque worker polls the Redis server to retrieve the key and performs a predefined job based on the retrieved key.

13. The system of claim 1, wherein the processor-based server further comprises at least one or more of the following proposal engines:
a criteria definer to define one or more criteria for selecting one or more outdoor advertising units;
an information gatherer to define information related to the advertiser and the advertising campaign;
a unit inventory searcher to provide a selectable pool of outdoor advertising units;
a unit selector to select one or more outdoor advertising units from the selectable pool of outdoor advertising units;
a POI definer to define one or more places of interest or reference locations;
a mapper to map said one or more outdoor advertising units to an interactive map;
a proposal assembler to assemble said information related to the advertiser, the advertising campaign, the interactive map, said one or more outdoor advertising unit into a proposal;
a proposal viewer to access the proposals by the client devices; and
a notification engine to provide notifications to the advertiser and the multimedia owners via their respective client devices.

14. The system of claim 1, wherein the requests are HTTP requests and are transported over the communications network using a TCP protocol.

15. The system of claim 1, wherein the server processor is configured to track real-time changes to the inventory quality coefficient for each outdoor advertising unit selected for the advertising campaign.
